(19) United States
(12) Patent Application Publication
(10) Pub. No.: US 2026/0057160 A1
(43) Pub. Date: Feb. 26, 2026

(54) GENERATING PARAMETERS FOR STATISTICAL TIMING ANALYSIS OF A CIRCUIT

(71) Applicant: International Business Machines Corporation, Armonk, NY (US)

(72) Inventors: Eric Foreman, Fairfax, VT (US); Natesan Venkateswaran, Hopewell Junction, NY (US); Kerim Kalafala, Rhinebeck, NY (US); Hemlata Gupta, Hopewell Jct, NY (US)

(21) Appl. No.: 18/810,682

(22) Filed: Aug. 21, 2024

(51) Int. Cl. G06F 30/3315; G06F 119/06; G06F 119/08; G06F 119/12

(52) U.S. Cl. CPC G06F 30/3315; G06F 2119/06; G06F 2119/08; G06F 2119/12

(57) ABSTRACT

Examples described herein provide a computer-implemented method that includes receiving a circuit design and a set of known process, voltage, and temperature (PVT) points for components of the circuit design. The method further includes determining parameter ratios for the set of known PVT points. The method further includes performing a statistical static timing analysis on the circuit design using the set of known PVT points and at least one additional PVT point generated during the statistical static timing analysis. The method further includes performing projections and root sum squaring for possible corners in a parameter space based on a canonical model generated during performing the statistical static timing analysis.

### BACKGROUND

The present disclosure relates to computing environments, and more specifically, to generating parameters for statistical timing analysis of a circuit.

Circuits can experience failures because of design or manufacturing defects. It is useful to predict when such failures may occur. Circuit design analysis techniques can be used to predict circuit failures, enabling the circuits to be assessed for reliability and performance under various conditions.

### SUMMARY

According to an embodiment, a computer-implemented method for generating parameters for statistical timing analysis of a circuit is provided. The method includes receiving a circuit design and a set of known process, voltage, and temperature (PVT) points for components of the circuit design. The method further includes determining parameter ratios for the set of known PVT points. The method further includes performing a statistical static timing analysis on the circuit design using the set of known PVT points and at least one additional PVT point generated during the statistical static timing analysis. The method further includes performing projections and root sum squaring for possible corners in a parameter space based on a canonical model generated during performing the statistical static timing analysis.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2 illustrates a plot of process, temperature, and voltage points, according to an embodiment;

FIG. 3 illustrates a plot of process, voltage, and temperature (PVT) points, according to an embodiment;

FIG. 4 illustrates a plot of the PVT points of FIG. 3 and additional PVT points, according to an embodiment;

FIG. 5 illustrates process variation for (hyper-) sphere versus (hyper-) multi-corner statistical timing analysis, according to an embodiment;

FIG. 6 illustrates a flow diagram of a method for generating parameters for statistical timing analysis of a circuit, according to an embodiment;

FIG. 7 illustrates a flow diagram of a method for generating libraries for multi-corner statistical timing analysis of a circuit, according to an embodiment;

FIG. 8 illustrates a block diagram of a system to perform circuit design optimization according to one or more embodiments; and

FIG. 9 illustrates a flow diagram of a method of fabricating an integrated circuit according to one or more embodiments.

### DETAILED DESCRIPTION

One or more embodiments described herein provide for generating parameters for statistical timing analysis of a circuit.

Circuit design analysis involves evaluating the performance and functionality of electronic circuits. One component of circuit design analysis is static timing analysis (STA), which analyzes whether a circuit design satisfies desired speed requirements for the circuit design by verifying that signals propagate through the circuit within acceptable time limits. Two approaches to STA are deterministic timing analysis and statistical timing analysis.

Deterministic timing analysis uses fixed values for delays and other parameters to provide a worst-case scenario evaluation. This approach assumes that the elements of the circuit, such as gates and wires, have constant, predefined delays. The deterministic timing analysis calculates the longest path that a signal might take through the circuit (known as the “critical path”) to ensure the circuit design meets the desired clock period.

Statistical timing analysis (also referred to as “statistical static timing analysis” or “SSTA”) accounts for variations in process, voltage, and temperature (PVT) by using probability distributions instead of fixed values as in determining timing analysis. This approach models delays as random variables and uses statistical methods to estimate the probability of timing violations. Statistical timing analysis provides a distribution of potential timing outcomes, rather than a single worst-case scenario.

One use-case for performing STA is for analyzing very-large-scale integration (VLSI) circuit designs. VLSI circuit designs may have too many parameters to dynamically time, and thus simulating the entire VLSI circuit design may be impractical. However, STA can be performed for VLSI circuit designs by propagating along circuit paths the latest delay values to verify signals traveling through the circuit arrive at the appropriate time at a particular component (e.g., flip flop). With advent of more variability in manufacturing (e.g., due to decrease in size of transistors and adding more complexity to architecture of chip design), being able to simulate in the STA can be limited when not considered variability (e.g., signals can arrive too early or too late). If adding variability, the operating conditions and process conditions are further considerations. In some cases, it may be desirable to evaluate timing at a large number of corners (e.g., plus/minus three standard deviations).

When receiving process, voltage, temperature (PVT) points for a circuit design (such as from a foundry), there may be limited PVT points to complete a full separable parametrization during timing analysis. Instead, there is guard-banding applied to a limited number of PVT corners. This results in over-margining and potentially limited margin on critical paths of the circuit design, which can lead to hardware failures of the circuit. It is therefore desirable to increase the number of PVT points.

One or more embodiments described herein address these and other shortcomings by generating additional PVT points using existing or known PVT points. One or more embodiments generates 2n+1 PVT points from 2n existing or known PVT points by pre-characterizing relationships between the 2N existing or known PVT points, thereby providing an inference on how to break apart the 2n existing or known PVT points into 2n+1 PVT points when performing finite differencing.

It should be appreciated that there are multiple methods to define relationships between existing or known PVT points according to one or more embodiments. A full parameterization approach enables multi-dimensional statistical timing without using over margining. The full parameterization approach also provides for investigation of timing behavior across multiple sigma sampling points within the parameter space.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

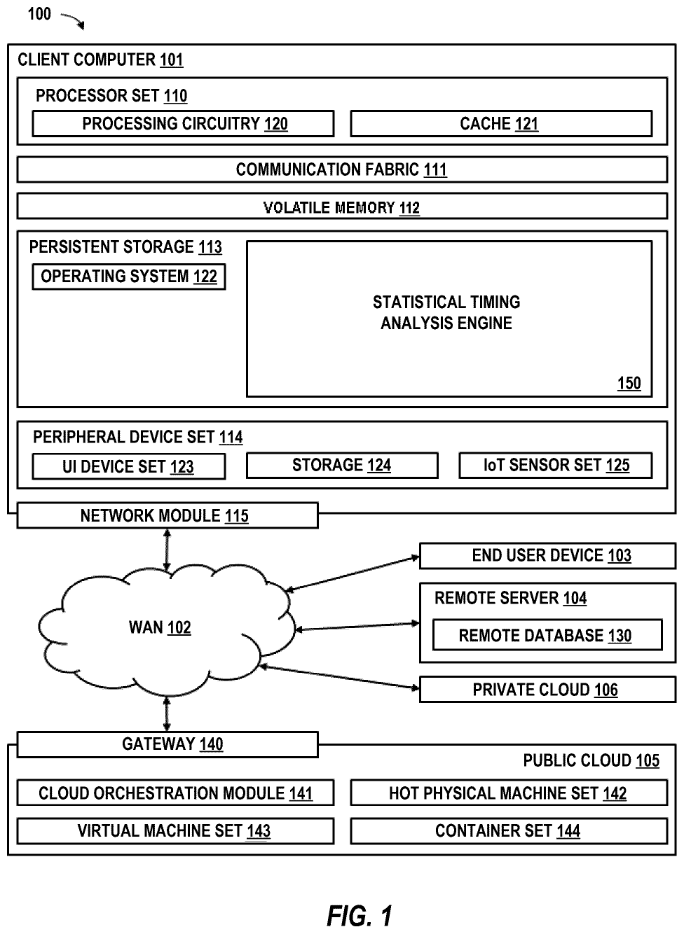

FIG. 1 illustrates a computing environment 100, according to an embodiment. Computing environment 100 contains an example of an environment for the execution of at least some of the computer code involved in performing the inventive methods, such as a statistical timing analysis engine 150 for generating parameters for statistical timing analysis of a circuit. In addition to the statistical timing analysis engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the statistical timing analysis engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the statistical timing analysis engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the statistical timing analysis engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the statistical timing analysis engine 150 uses a canonical model to perform statistical timing analysis. The canonical model provides a simplify and standardize the representation of circuit elements, making it easier to analyze and predict circuit behavior under various conditions. According to one or more embodiments, a canonical model is a bi-linear delay distribution having multiple sources of variation and cross terms with respect to a single base layer. According to one or more embodiments, delay quantities have an early (smallest) and late (largest) value represented by early and late canonical models, respectively.

According to one or more embodiments, the statistical timing analysis engine 150 uses an extended canonical model that includes first order canonical model terms as well as cross-terms or “second-order terms.” For example, the following formula shows an extended canonical model that may be used by the statistical timing analysis engine 150 to perform SSTA:

$${a}_{0} + {a}_{1} Δ {X}_{1} + {a}_{2} Δ {X}_{2} + {a}_{1 , 2} Δ {X}_{1} Δ {X}_{2} … + {a}_{n + 1} Δ {R}_{a}$$

where a₀ is a constant (nominal) value in the absence of variations, a₁ and a₂ are sensitivities, ΔX₁ and ΔX₂ are global random variables (e.g., probability distributions), a_{1,2}ΔX₁ΔX₂ is a second-order term, and aₙ₊₁ΔRₐ is an independently random uncertainty. The second-order term is a function of technology and how a first order variability distribution impacts the variation of another first order variability distribution. For example, process variation can be different at a relatively higher voltage as compared to a relatively lower voltage. Therefore, a second order term (for this example) would represent process variation changing as voltage is changing.

According to one or more embodiments, the canonical model is generated for each block (gate/net) delay in the circuit design. The delay canonical is propagated to computed arrival times and desired arrival times. The propagated data is used to compute slack canonical, and then the slack canonical is projected to the process sub-space of interest for timing sign-off.

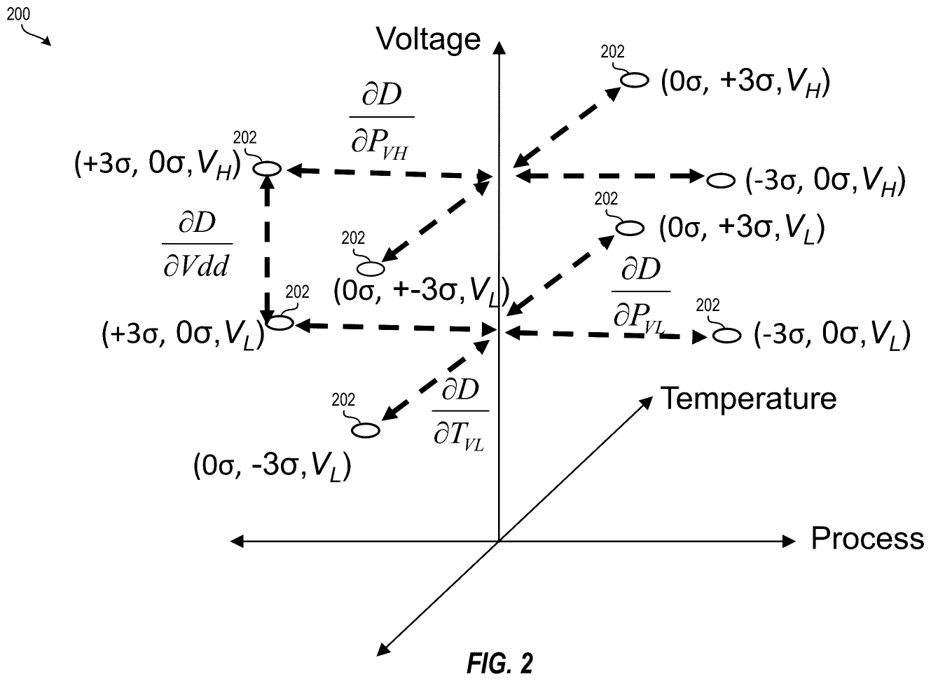

Turning now to FIG. 2, a plot 200 of process (P), voltage (V), and temperature (T) (PVT) points 202 is shown, according to an embodiment. The plot 200 is a three-dimensional plot that includes a process axis, a temperature axis, and a voltage axis, and the PVT points 202 are plotted accordingly. The dashed arrows between the PVT points 202 show the sensitivity that can be computed from the difference of the PVT points. In this example, the statistical timing analysis engine 150 computes the temperature and process sensitivity twice: once at a higher voltage and once at a lower voltage. The difference between the higher voltage and the lower voltage represents second-order behavior. The following table shows formulas for first order terms and second order terms describe the details of the sensitivity being computed in terms of distance (D), lower voltage (LV), and higher voltage (HV), where σ is the standard deviation.

| | | |
|---|---|---|
| First Order Term | $\frac{\partial D}{\partial Vdd} = ( \frac{{D}_{VH} - {D}_{VL}}{{σ}_{VH} - {σ}_{VL}} )$ | This is the delay sensitivity to voltage |
| First Order Term | $\frac{\partial D}{\partial {P}_{VH , VL}} = ( \frac{{D}_{P 1} - {D}_{P 2}}{{σ}_{P 1} - {σ}_{P 2}} )$ | This is the delay sensitivity to process (computed twice at lower |
| | | voltage and higher voltage) |
| First Order Term | $\frac{\partial D}{\partial {T}_{VH , VL}} = ( \frac{{D}_{T 1} - {D}_{T 2}}{{σ}_{T 1} - {σ}_{T 2}} )$ | This is the delay sensitivity to temperature (computed twice at lower |
| | | voltage and higher voltage) |
| Second Order Term | $( \frac{\partial D}{\partial Vdd} ) ( \frac{\partial D}{\partial P} ) = ( \frac{1}{{σ}_{VH} - {σ}_{VL}} ) ( \frac{\partial D}{\partial {P}_{VH}} - \frac{\partial D}{\partial {P}_{VL}} )$ | This is the delay sensitivity to process with respect to voltage |
| Second Order Term | $( \frac{\partial D}{\partial Vdd} ) ( \frac{\partial D}{\partial T} ) = ( \frac{1}{{σ}_{VH} - {σ}_{VL}} ) ( \frac{\partial D}{\partial {T}_{VH}} - \frac{\partial D}{\partial {T}_{VL}} )$ | This is the delay sensitivity to temperature with respect to voltage |

It should be appreciated that the second order terms can be extended to more sources of variation according to one or more embodiments. The second order terms are a result of computing the first order terms twice (e.g., at two different voltage conditions). According to one or more embodiments, the first order terms and the second order terms are normalized per unit of standard deviation (σ).

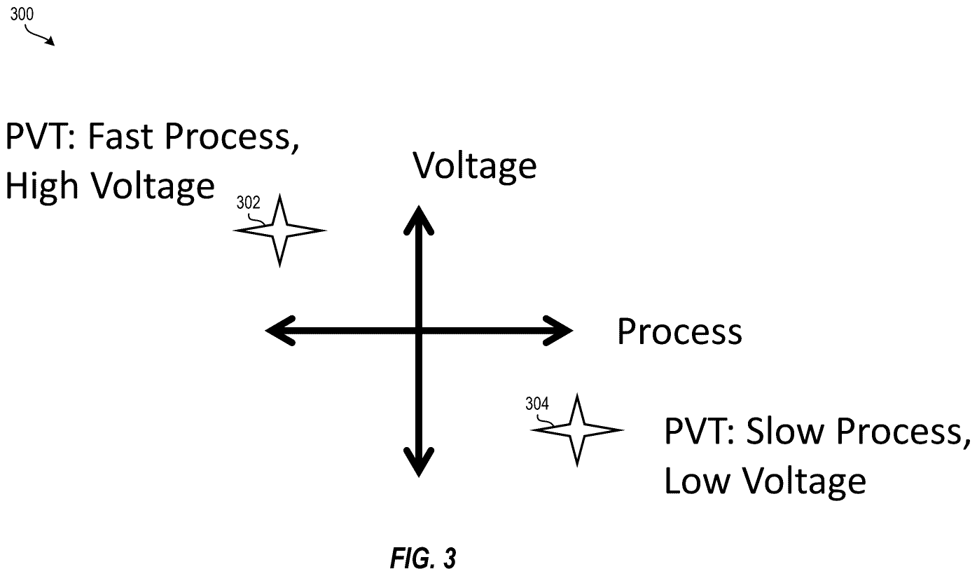

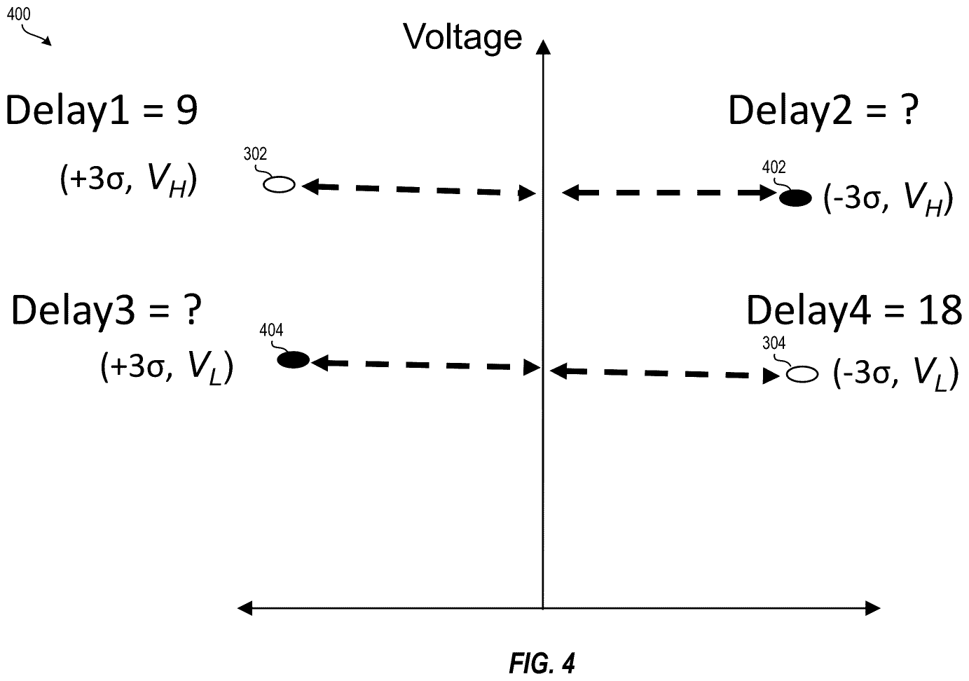

With reference to FIG. 3, a plot 300 of PVT points 302, 304 is shown, according to an embodiment. The PVT point 302 is for a faster process and higher voltage, while the PVT point 304 is for a slower process and lower voltage (relative to the PVT point 302). It may be desirable to compute one or more additional PVT points based on the PVT points 302, 304, for example. The two PVT points 302 are essentially the end points of the distribution; however, two things are changing: processing and voltage. One or more embodiments described herein take a single distribution of process/voltage and break it apart into two separate distributions, one of process and one of voltage. By breaking it apart, additional PVT points can be computed, as is now described in more detail with reference to FIG. 4.

FIG. 4 depicts a plot 400 of PVT points 302, 304 and additional PVT points 402, 404, according to an embodiment.

According to one or more embodiments, it can be assumed that the PVT points 302, 304 are known and it is desirable to determine the additional PVT points 402, 404. For this example, it is assumed that the voltage and process points are at +/−3 standard deviations.

To do this, the statistical timing analysis engine 150 computes the delay value (e.g., a vector of sensitivity) for each of the additional PVT points 402, 404 according to the following equations:

$$\frac{\partial D}{\partial Vdd} = ( \frac{{D}_{VH} - {D}_{VL}}{{σ}_{VH} - {σ}_{VL}} ) \qquad ( eq . 1 )$$

$$\frac{\partial D}{\partial {P}_{VH , VL}} = ( \frac{{D}_{P 1} - {D}_{P 2}}{{σ}_{P 1} - {σ}_{P 2}} ) \qquad ( eq . 2 )$$

$$Delay = μ + {α}_{Si} {σ}_{Si} + {α}_{VDD} {σ}_{VDD} \qquad ( eq . 3 )$$

where μ is the mean of the distribution, aₛᵢ represents a multiplier that scales parameter sensitivity to new PVT points, a_{VDD} is a multiplier that indicates how silicon sensitivity changes from higher voltage to lower voltage current (e.g., how second order sensitivity changes with respect to voltage), and σ_{Si} is a sensitivity of silicon process sensitivity.

A ratio of how voltage sensitivity varies as compared to silicon process sensitivity when both parameters move together in one parameter is calculated using the following equation:

$${σ}_{β} = \frac{{σ}_{VDD}}{{σ}_{Si}} \qquad ( eq . 4 )$$

According to one or more embodiments, machine learning can be used to infer other possible PVT values using σ_{β} to train a model to determine how voltage changes as process changes.

At the PVT point 302, the delay is 9 for higher voltage and faster process, and for the PVT point 304, the delay is 18 for lower voltage and the faster process. Now if the difference of the delay of the PVT point 302 and the delay of the PVT point 304 are taken, this results in process and voltage changing at the same time. The difference between the delay for the PVT points 302, 304 is normalized using the +/−3 standard deviations using a “STD normalization” value of 6 (e.g., −3−3) as follows:

$$\frac{Delay ( point 302 ) - Delay ( point 304 )}{{STD}_{normalization}} = \frac{9 - 18}{6} = - 1.5 \frac{picoseconds}{unit sigma} .$$

The circuit design can be characterized to determine that, for the delay arc, the beta ratio of equation 4 is:

$${σ}_{β} = \frac{{σ}_{VDD}}{{σ}_{Si}} = 2.8 / 1 = 2.8 .$$

Then, the ratio can be rewritten in terms such that

$${σ}_{si} = \frac{{σ}_{VDD}}{2.8}$$

so, −1.5 picoseconds/unit sigma is the combined movement of voltage (VDD) and process. This can be broken apart using the ratio defined above as follows:

Sensed voltage+sensed process=−1.5,→2.8X+1X=−1.5, X=−0.39, so sensitivity process x*1=−0.39, and sensitivity voltage=2.8*−0.39=−1.09.

The delay value (e.g., Delay3) for the additional PVT point 404 can be computed using equation 1 such that the PVT is (9−Delay3)/6=−1.09, Delay3=15.15.

The delay value (e.g., Delay2) for the additional PVT point 402 can be computed using equation 2 such that the PVT is (9−Delay2)/6=−0.39, Delay2=11.34.

The statistical timing analysis engine 150 computes the mean for process (μ_{SI}) for process and the mean for voltage (μ_{VDD}) as follows:

$${μ}_{VDD} = ( 9 + 15.15 ) / 2 = 12.25 ,$$

$${μ}_{SI} = ( 9 + 11.34 ) / 2 = 10.17 .$$

The statistical timing analysis engine 150 can then compute an overall joint mean (μ) from equation 3 can be computed (using, for example Delay2):

$$11.31 = μ + ( - 3 ) ( - 0.39 ) + ( 3 ) ( - 1.09 )$$

where solving for the mean (μ) results in μ=13.44. Now equation 3 can also be used to project any process/voltage point in the parameter space according to one or more embodiments.

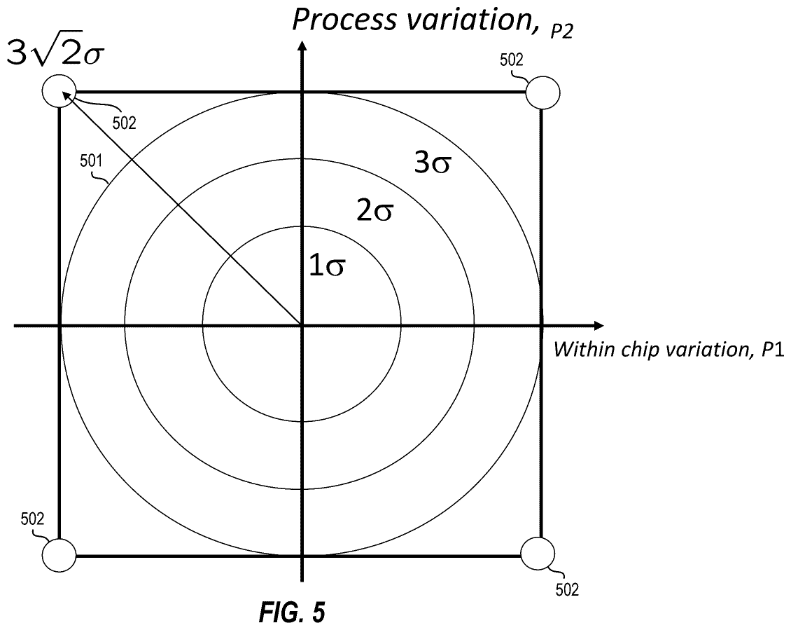

Turning now to FIG. 5, process variation for (hyper-) sphere versus (hyper-) multi-corner statistical timing analysis is shown, according to an embodiment. The “worst” point of the points 502 is referred to as an “exhaustive corner timing” and is considered the worst because it has the longest delay. In this example, regions of low probability are included. Performance is limited by the most limiting path at the most limiting (“worst”) corner. It should be appreciated that virtually the same parametric yield can be obtained within 30 coverage within the circle 501. If the sensitivity of P1 (within chip variation) and root sum square (RSS) with sensitivity of P2 (process variation), then the circle 501 is generated instead of the corners having the points 502. This allows for pessimism reduction when using statistical timing.

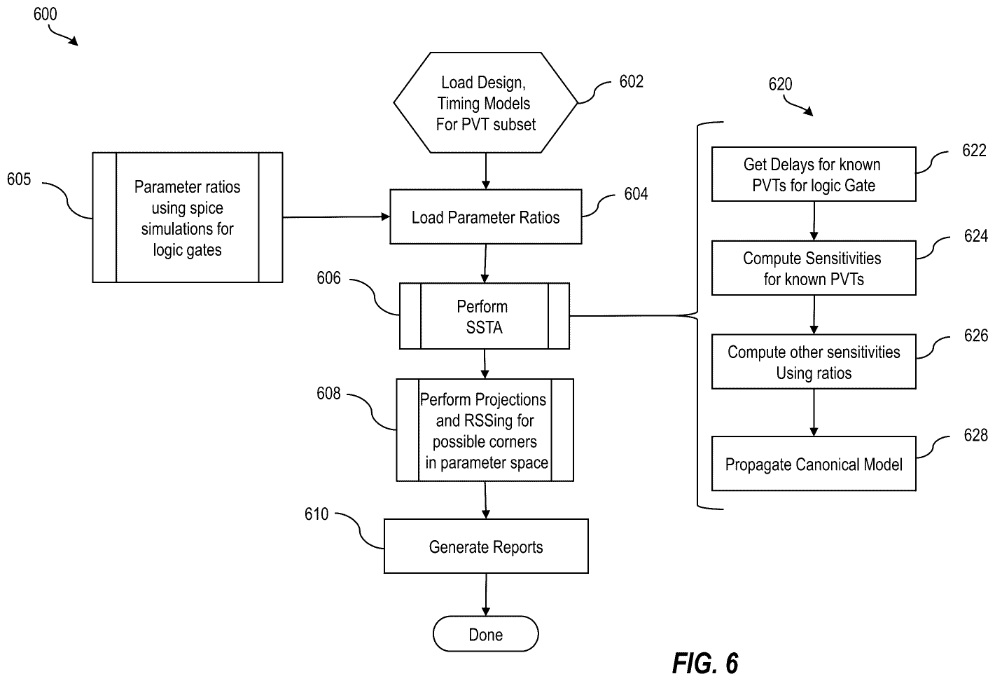

FIG. 6 illustrates a flow diagram of a method 600 for generating parameters for statistical timing analysis of a circuit, according to an embodiment. The method 600 can be performed by any suitable computing system, device, or environment, such as those described herein. The method 600 is now described with reference to the computing environment 100, and particularly the statistical timing analysis engine 150, but is not so limited.

At block 602, the statistical timing analysis engine 150 loads a circuit design and timing models for at least a subset of PVT points. The circuit design and timing models can be received, for example, from a foundry. At block 604, the statistical timing analysis engine 150 loads parameter ratios 605. The parameter ratios 605 are generated, for example, using spice simulations for components of the circuit design (e.g., logic gates). At block 606, the statistical timing analysis engine 150 performs SSTA 620, which is now described in more detail.

The SSTA 620 begins at block 622, where the statistical timing analysis engine 150 receives delays for the known PVT points (e.g., the PVT points 302, 304) for logic gates. At block 624, the statistical timing analysis engine 150 computes sensitivities for the known PVT points (e.g., the PVT points 302, 304) as described herein (see, e.g., discussion of FIG. 4). At block 626, the statistical timing analysis engine 150 computes other sensitivities for additional PVT points using ratios as described herein regarding equation 4, for example. At block 628, the statistical timing analysis engine 150 propagates a canonical model (e.g., with the sensitivities computed at blocks 624 and 626).

Once the SSTA 620 has been performed at block 606, the method 600 continues to block 608, where the statistical timing analysis engine 150 performs projections and root sum squaring (RSSing) (e.g., to combine variation from different PVT variations) for the possible corners in a parameter space. To do this, the statistical timing analysis engine 150 uses the canonical model propagated at block 628, for example. At block 610, the statistical timing analysis engine 150 generates one or more reports, which include information and results about the SSTA 620, such as delays. The report(s) can be used to refine/improve the circuit design and/or to fabricate a circuit using the circuit design. The method 600 can then terminate.

Additional processes also may be included, and it should be understood that the processes depicted in FIG. 6 represent illustrations, and that other processes may be added or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

According to one or more embodiments, multiple sets of libraries (“libs” or “.libs”) are used that represent the characterized delays for circuits. For example, N number of .libs may be used to characterize the delays, where N is the number of corners (e.g., for 7 corners, 7 .libs are used). It can be inefficient, costly, and time consuming to acquire libraries, often from multiple vendors. However, having fewer libraries means lower coverage and thus limited PVT points. The embodiments described herein provide for creating additional PVT points from existing PVT points.

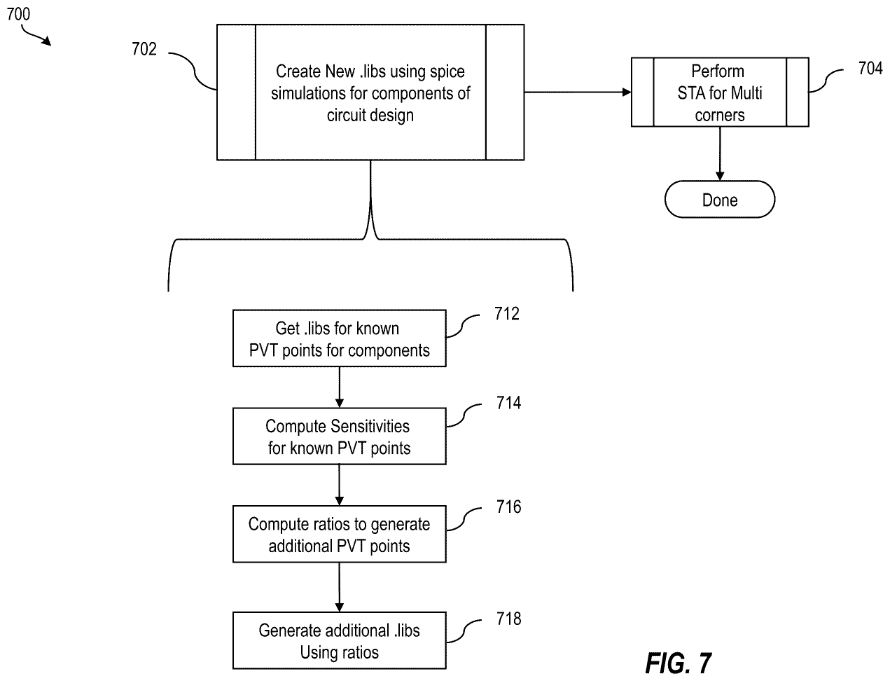

FIG. 7 illustrates a flow diagram of a method 700 for generating libraries for multi-corner statistical timing analysis of a circuit, according to an embodiment. The method 700 can be performed by any suitable computing system, device, or environment, such as those described herein. The method 700 is now described with reference to the computing environment 100, and particularly the statistical timing analysis engine 150, but is not so limited.

At block 702, the statistical timing analysis engine 150 creates new libraries (.libs) using spice simulations for components of a circuit design (e.g., logic gates). To do this, the statistical timing analysis engine 150 gets libraries (.libs) for known PVT points (e.g., the PVT points 302, 304) for the components (e.g., logic gates) at block 712. At block 714, the statistical timing analysis engine 150 computes sensitivities for the known PVTs as described herein. At block 716, the statistical timing analysis engine 150 computes rations to generate additional PVT points (e.g., the additional PVT points 402, 404) as described herein. At block 718, the statistical timing analysis engine 150 generates additional libraries (.libs) for the additional PVT points using the ratios computed at block 716.

At block 704, once the additional libraries are generated for the additional PVT points, the statistical timing analysis engine 150 performs statistical timing analysis for multiple corners as described herein.

Additional processes also may be included, and it should be understood that the processes depicted in FIG. 7 represent illustrations, and that other processes may be added or existing processes may be removed, modified, or rearranged without departing from the scope of the present disclosure. It should also be understood that the processes depicted in FIG. 7 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

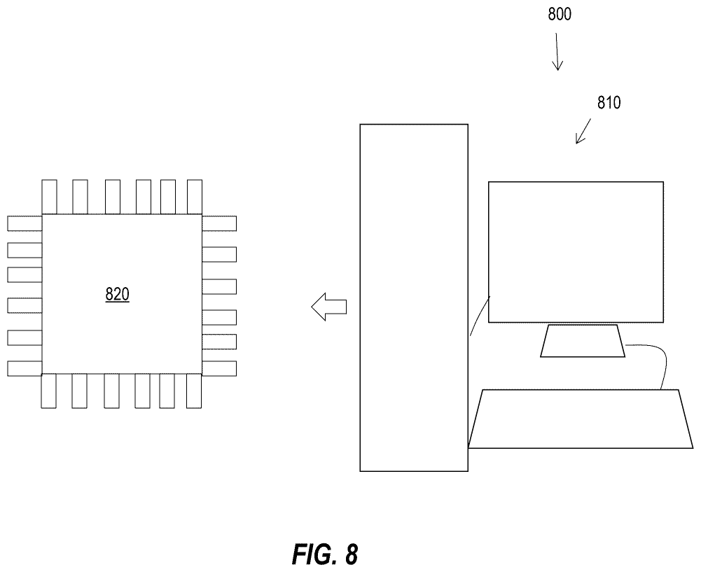

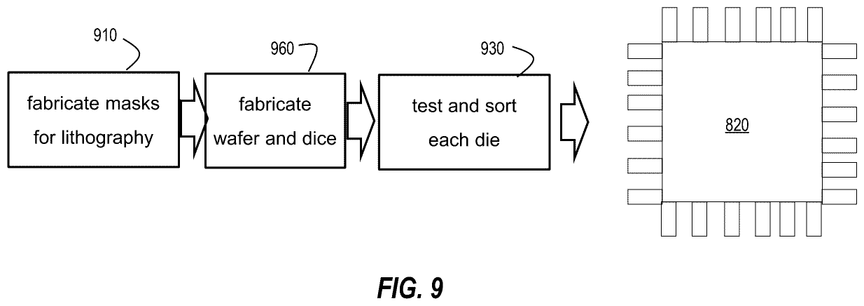

FIG. 8 is a block diagram of a system 800 to perform circuit design optimization according to one or more embodiments. The system 800 includes processing circuitry 810 used to generate the circuit design that is ultimately fabricated into an integrated circuit 820. The steps involved in the fabrication of the integrated circuit 820 are well-known and briefly described herein. Once the physical layout is finalized, based, in part, on the circuit design optimization according to one or more embodiments, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 9.

Particularly, FIG. 9 is a flow diagram of a method 900 of fabricating an integrated circuit according to one or more embodiments. Once the physical design data is obtained, based, in part, on performing circuit design optimization as described herein, the integrated circuit 820 can be fabricated according to known processes that are generally described with reference to FIG. 9. Generally, a wafer with multiple copies of the final design is fabricated and cut (i.e., diced) such that each die is one copy of the integrated circuit 820. At block 910, the processes include fabricating masks for lithography based on the finalized physical layout. At block 920, fabricating the wafer includes using the masks to perform photolithography and etching. Once the wafer is diced, testing and sorting each die is performed, at block 930, to filter out any faulty die.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving a circuit design and a set of known process, voltage, and temperature (PVT) points for components of the circuit design;
determining parameter ratios for the set of known PVT points;
performing a statistical static timing analysis on the circuit design using the set of known PVT points and at least one additional PVT point generated during the statistical static timing analysis; and
performing projections and root sum squaring for possible corners in a parameter space based on a canonical model generated during performing the statistical static timing analysis.

2. The computer-implemented method of claim 1, further comprising generating a report based at least in part on results of the projections and root sum squaring.

3. The computer-implemented method of claim 2, further comprising fabricating a circuit based at least in part on the results.

4. The computer-implemented method of claim 1, wherein the parameter ratios are generated using spice simulations for components of the circuit design.

5. The computer-implemented method of claim 1, wherein performing the statistical static timing analysis comprises receiving delays for the set of known PVT points.

6. The computer-implemented method of claim 5, wherein performing the statistical static timing analysis comprises computing sensitivities for the set of known PVT points.

7. The computer-implemented method of claim 6, wherein performing the statistical static timing analysis comprises computing at least one additional sensitivity used to generate the at least one additional PVT point.

8. The computer-implemented method of claim 7, wherein performing the statistical static timing analysis comprises propagating the canonical model using sensitivities for the set of known PVT points and the at least one additional sensitivity used to generate the at least one additional PVT point.

9. The computer-implemented method of claim 1, further comprising generating libraries for the at least one additional PVT point.

10. A system comprising:
a memory comprising computer readable instructions; and
a processing device for executing the computer readable instructions, the computer readable instructions controlling the processing device to perform operations comprising:
receiving a circuit design and a set of known process, voltage, and temperature (PVT) points for components of the circuit design;
determining parameter ratios for the set of known PVT points;
performing a statistical static timing analysis on the circuit design using the set of known PVT points and at least one additional PVT point generated during the statistical static timing analysis; and
performing projections and root sum squaring for possible corners in a parameter space based on a canonical model generated during performing the statistical static timing analysis.

11. The system of claim 10, wherein the operations further comprise generating a report based at least in part on results of the projections and root sum squaring.

12. The system of claim 11, wherein the operations further comprise fabricating a circuit based at least in part on the results.

13. The system of claim 10, wherein the parameter ratios are generated using spice simulations for components of the circuit design.

14. The system of claim 10, wherein performing the statistical static timing analysis comprises receiving delays for the set of known PVT points.

15. The system of claim 14, wherein performing the statistical static timing analysis comprises computing sensitivities for the set of known PVT points.

16. The system of claim 15, wherein performing the statistical static timing analysis comprises computing at least one additional sensitivity used to generate the at least one additional PVT point.

17. The system of claim 16, wherein performing the statistical static timing analysis comprises propagating the canonical model using sensitivities for the set of known PVT points and the at least one additional sensitivity used to generate the at least one additional PVT point.

18. The system of claim 10, wherein the operations further comprise generating libraries for the at least one additional PVT point.

19. A computer program product comprising:
a set of one or more computer-readable storage media;
program instructions, collectively stored in the set of one or more storage media, for causing a processor set to perform the following computer operations:
receiving a circuit design and a set of known process, voltage, and temperature (PVT) points for components of the circuit design;
determining parameter ratios for the set of known PVT points;
performing a statistical static timing analysis on the circuit design using the set of known PVT points and at least one additional PVT point generated during the statistical static timing analysis; and
performing projections and root sum squaring for possible corners in a parameter space based on a canonical model generated during performing the statistical static timing analysis.

20. The computer program product of claim 19, wherein the operations further comprise generating a report based at least in part on results of the projections and root sum squaring.
